(19) United States
(12) Patent Application Publication
(10) Pub. No.: US 2022/0143969 A1
(43) Pub. Date: May 12, 2022

(54) COLOR VARIATION MITIGATION FOR INTER-PEN ERROR HIDING

(71) Applicant: HEWLETT-PACKARD DEVELOPMENT COMPANY, L.P., Spring, TX (US)

(72) Inventors: Carlota GALINDO QUINTAS, Sant Cugat del Valles (ES); Antonio GRACIA VERDUGO, Sant Cugat del Valles (ES); Andrei ALEXANDRU DAFINOIU, Sant Cugat del Valles (ES)

(21) Appl. No.: 17/423,437

(22) PCT Filed: Jan. 30, 2019
(86) PCT No.: PCT/US2019/015883

§ 371 Date: Jul. 15, 2021

(51) Int. Cl. B41J 2/045

(52) U.S. Cl. CPC B41J 2/0451; B41J 2/04586

(57) ABSTRACT

A method of printing, the method comprising: monitoring operation of first nozzles of a first nozzle array, and if malfunction of a number of first nozzles of the first nozzle array is detected, setting a number of second nozzles of a second nozzle array to a compensation mode. Monitoring operation of the number of second nozzles in the compensation mode and, in response to detecting that a printing parameter of the number of second nozzles differs from a reference printing parameter, adjusting an operation mode parameter of a subset of second nozzles.

### BACKGROUND

Printers are exposed to drop weight variability triggered by diverse factors like printhead factory characteristics and age of the printhead, but also by firing frequency. Since the settings of a printhead for printing a color with a given color parameter, such as saturation, brightness and hue, are related to the number of drops and to the drop weight, variations in the drop weight can result in color variation when printing.

### BRIEF DESCRIPTION OF THE FIGURES

FIG. 1 is a schematic illustration of a printing device according to an example.

FIG. 2 is a schematic illustration of a printhead device of a printing device according to an example.

FIG. 3 is a flow diagram representing a method of printing according to an example.

FIG. 4 shows a graph for a printing method according to an example.

FIG. 5 shows a graph for a printing method according to an example.

FIG. 6 is a schematic illustration of a printing device according to an example.

FIG. 7 is a schematic illustration of a printhead device of a printing device according to an example.

FIG. 8 is a flow diagram representing a method of printing according to an example.

### DETAILED DESCRIPTION

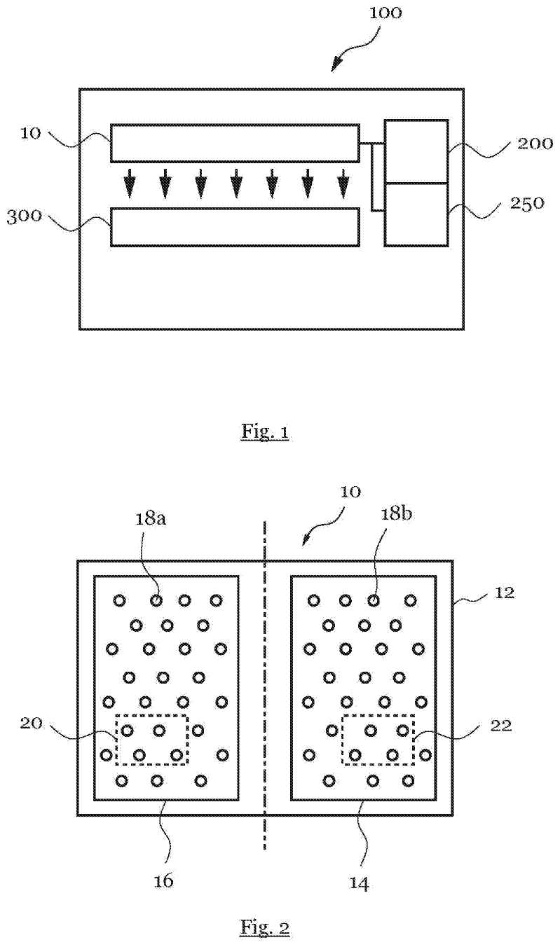

FIG. 1 is a schematic illustration of a printing device 100 according to an example. The printing device 100 comprises a printhead device 10, a control unit 200, and a recalibration unit 250. The printing device 100 is a printing device for depositing a printing fluid, for example ink, by means of the printhead device 10 on a printing medium 300. The printing fluid is ejected by printing nozzle of the printhead device and thereby deposited on the printing medium 300. The printing medium 300 may comprise paper, cardboard, plastic, metal, or any other printable medium.

The printing device 100 illustrated in FIG. 1 may correspond in some examples to a dye sublimation printer or to an inkjet printer, although it may also correspond to another type of printer.

In some examples, the printhead device 10 may comprise one or more printheads for ejecting the ink or the printing fluid onto the printing medium 300 along a printing direction indicated by arrows in FIG. 1 while moving in a direction perpendicular to the printing direction in order to reach different parts of the printing medium 300. The printhead device 10 may comprise or be connectable to a carriage device 12, such that one or more printheads of the printhead device 10 may be supported by the carriage device 12. A printhead may comprise a nozzle array, for example a two-dimensional arrangement of nozzles with a regular pattern such as one or more of a square lattice, a rectangular lattice, a rhombic lattice, a hexagonal lattice and an oblique lattice.

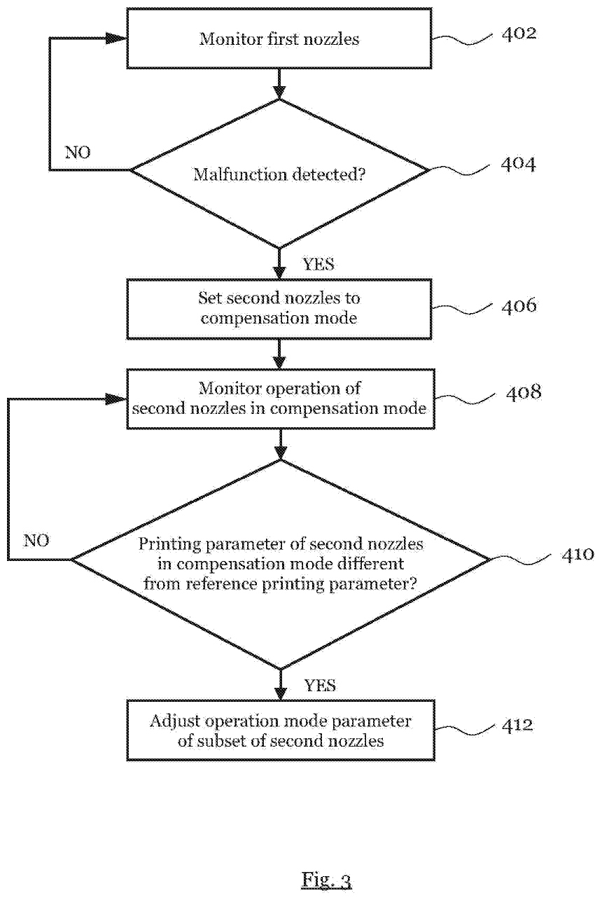

FIG. 2 is a schematic illustration of a printhead device 10 according to some examples, which comprises a carriage 12, wherein the carriage 12 comprises a first nozzle array 16 and a second nozzle array 14. The first nozzle array 16 comprises a plurality of first nozzles 18a for depositing the printing fluid onto the printing medium 300 shown in FIG. 1. The second nozzle array 14 comprises a plurality of second nozzles 18b for ejecting the printing fluid into the printing medium 300 shown in FIG. 1.

Although an example printhead device that comprises a pair of nozzle arrays is described in FIG. 2, printhead devices according to other examples may also comprise any greater number of nozzle arrays, for example an even number of pairwise paired nozzle arrays greater than two. However, some examples may also comprise an odd or even number of otherwise paired nozzle arrays greater than two, for example, an even number of nozzle arrays in which more than one nozzle arrays may be paired with another nozzle array.

In some examples, the first nozzle array 16 may be part of a first printhead and the second nozzle array 14 may be part of a second printhead. The first printhead and the second printhead may eject a same type of printing fluid, for instance a same type of ink or ink of the same color to deposit the printing fluid onto the printing medium 300. In some examples, however, the first nozzle array 16 and the second nozzle array 14 may be part of the same printhead, and may for example be overlying nozzle arrays, such that for each first nozzle 18a at a position in the first nozzle array 16 there is a second nozzle 18b at a corresponding position of the second nozzle array 16. The first and second nozzle arrays 16, 14 may however also be interspersed nozzle arrays of a printhead, such that one first nozzle 18a may be surrounded by one or more second nozzles 18b and vice versa.

In some examples, the first nozzle array 16 and the second nozzle array 14 may comprise equal numbers of nozzles 18a, 18b. In some examples, the position of the second nozzles 18b of the second nozzle array 14 may have a symmetric arrangement with respect to the position of the corresponding first nozzles 18a of the first nozzle array 16, wherein such symmetric arrangement may for instance correspond to a mirror symmetry or to a translational symmetry with respect to an axis of symmetry located between the first nozzle array 16 and the second nozzle array 14.

The control unit 200 may monitor operation of the first nozzles 18a and of the second nozzles 18b. The control unit 200 may further control the first nozzle array 16 and the second nozzle array 14 such that, if malfunction of a number of the first nozzles 18a is detected, the control unit 200 may set a number of the second nozzles 18b in a compensation mode. A malfunction of the at least one of the first nozzles 18a can be detected by means of hardware components, software components or a combination thereof. For example a sensor, such as a drop detector, can be connected to the control unit 200 and a monitoring software can be implemented in the control unit 200 and operate based on measurements received from the sensor.

Alternatively or additionally, malfunction of the at least one of the first nozzles 18a can be detected by scanning a printed image, i.e. a result of printing with the printing device 100 on the printing medium 300, and evaluating one or more parameters of the printed image. In some examples, the first nozzles 18a may eject printing fluid upon the printing medium 300 such that print markings be printed on the printing medium 300, wherein each print marking is printed by or associated to one of the first nozzles 18a. By scanning the print markings, malfunctioning nozzles may be detected, for example based on print markings that are missing or weakened in a pattern of print markings.

According to some examples, a nozzle may be considered to be malfunctioning when it is blocked or clogged such that it may not eject the printing fluid in a predetermined or foreseen manner or such that it may not eject the printing fluid at all. However, a nozzle may also be considered to be malfunctioning when it is prevented from firing the printing fluid in a predetermined or foreseen manner or when it is prevented from firing any printing fluid at all due to a software-related failure.

Thus, each first nozzle 18a of the first nozzle array 16 may be paired, i.e. functionally associated, with a corresponding second nozzle 18b of the second nozzle array 14, such that when a malfunction of at least one of the first nozzles 18a is detected, a resulting disruption in a printing process can be compensated by setting, correspondingly, at least one of the second nozzles 18b in the compensation mode. The control unit 200 can thereby implement interpen error hiding.

As shown in FIG. 2, in some examples, a plurality of first nozzles 18a adjacent to each other may form a number of first nozzles 20 or first group of nozzles 20, and such number of first nozzles 20 may be paired with a corresponding number of second nozzles 22 or second group of nozzles 22, which are also adjacent to each other. Each first nozzle 18a of the number of first nozzles 20 may be paired with a corresponding second nozzle 18b of the number of second nozzles 22.

In some examples, the second nozzles 18b of the number of second nozzles 22 may be located at a position within the second nozzle array 14 corresponding to a position of the corresponding first nozzles 18a of the number of first nozzles 20 within the first nozzle array 16. As it can be seen in FIG. 2, the number of first nozzles 20 and the number of second nozzles 22 may have a symmetric arrangement with respect to each other, wherein such symmetric arrangement may for instance correspond to a mirror symmetry or to a translational symmetry with respect to an axis of symmetry of the printhead device 10 located between the first nozzle array 16 and the second nozzle array 14.

The printing device 100 shown in FIG. 1 further comprises a recalibration unit 250 to adjust an operation mode of a subset of the first and second nozzles 18a, 18b of the printhead device 10, when detecting that a printing parameter of the number of second nozzles 22 differs from a reference printing parameter. In some examples, the control unit 200 and the recalibration unit 250 may be hardware components, software components, or a combination thereof. In some examples, the control unit 200 and the recalibration unit 250 may be integrated with each other forming a control and recalibration unit. For example, the control unit 200 and the recalibration unit 250 can be integrated in a dedicated processor or in a printer controller.

A method of printing according to an example is represented as a flow diagram in FIG. 3. The method of printing may be implemented by the control unit 200 and the recalibration unit 250 of a printing device like the one described with respect to FIG. 1. The method may comprise monitoring (at 402) the operation of the first nozzles 18a of a first nozzle array 16 of a printing device 100.

Monitoring the operation of the first nozzles 18a may comprise detecting if at least one of the first nozzles 18a is malfunctioning, detecting a printing feature of a non-compensated operation mode of at least one non-malfunctioning nozzle, for example of at least a first nozzle 18a of the first nozzle array 16 that is not affected by the detected malfunctioning, and determining, based on the printing feature of the non-compensated operation mode, a compensation printing feature in which the number of second nozzles 18b are to be set when they are set to the compensation mode.

In some examples, the printing feature may correspond to a firing frequency. For example, monitoring the operation of the first nozzles 18a can comprise, after detecting that at least one of the first nozzles 18a is malfunctioning, detecting a standard firing frequency FF1 of non-malfunctioning first nozzles 18a of the first nozzle array 16 and defining a compensation firing frequency FF2 for the number of second nozzles 18b that are to be set to the compensation mode.

In some examples, the compensation firing frequency FF2 may be higher than the standard firing frequency FF1. In some examples, the compensation firing frequency FF2 may correspond to twice or about twice or at least twice the standard firing frequency FF1 of the non-compensated operation mode. The compensation firing frequency FF2 may however also be three times, four times or eight times higher than the standard firing frequency FF1, or it may be 1.5 or 2.5 times higher than the standard firing frequency FF1. The correspondence between the compensation firing frequency FF2 and the standard firing frequency FF1 may be related to or depend on the number of second nozzles that are paired with a first nozzle.

The method may further comprise setting a number of second nozzles 18b of the second nozzle array 14 to the compensation mode (at 406), when a malfunction of a number of first nozzles 18a or of at least one first nozzle 18a is detected (condition 404). Optionally, if no malfunction is detected, the method may comprise resuming monitoring (at 402) the operation of the first nozzles 18a of a first nozzle array 16 of a printing device 100. The number of second nozzles 18b that are set to the compensation mode may correspond to second nozzles 18b that are paired with the malfunctioning first nozzles 18a. For example, with reference to the printhead device 10 illustrated in FIG. 2, the method may comprise (at 406) setting the number of second nozzles 22 to the compensation mode, when a malfunction of the first nozzles of the number of first nozzles 20 is detected.

In some examples, setting a number of second nozzles 18b of the second nozzle array 14 to the compensation mode (at 406) may comprise controlling the number of second nozzles 18a to operate at the compensation firing frequency FF2.

By carrying out the sequence 402 to 406 represented in FIG. 3, the control unit 200 can implement interpen error hiding to compensate that the number of first nozzles 20 of the first nozzle array 16 is malfunctioning by setting a corresponding number of second nozzles 18b in the compensation mode, for example by correspondingly increasing the firing frequency with which such second nozzles eject the printing fluid. In some examples, the aforesaid corresponding number of second nozzles 18b may be the number of second nozzles 22.

According to some examples, for each malfunctioning first nozzle, at least one second nozzle may be set to the compensation mode. In this way, additional printing fluid may be ejected by at least one second nozzle that is set in the compensation mode for each malfunctioning first nozzle, such that an overall ink loss, which could result in a difference between a target color to be achieved and a printed color that is actually achieved when printing on the printing medium 300, can be suppressed or avoided.

In some examples, blocks 404 and 406 represented in FIG. 3 may be carried out under the proviso that a malfunction of at least a predefined number of mutually adjacent first nozzles 18a is detected, such that steps 404 and 406 in FIG. 3 are executed when it is detected that at least the aforesaid predefined number of mutually adjacent first nozzles is malfunctioning. The predefined number may be 5, 10, 15, 20, 25, 30, or 50. The malfunctioning first nozzles 18a may be adjacent to each other such that each of the malfunctioning first nozzles is adjacent to at least another one of the malfunctioning first nozzles. In this way, interpen error hiding is applied when the effect of malfunctioning nozzles could be perceivable on the printing medium 300 after printing.

In some examples, the number of second nozzles 22 may equal the number of first nozzles 20, such that for each malfunctioning first nozzle, a corresponding second nozzle can be set to the compensation mode. If the number of first nozzles 20 comprises a predefined number of adjacent first nozzles 18a, the number of second nozzles 22 may also correspondingly comprise at least a quantity of mutually adjacent second nozzles 18b corresponding to the aforesaid predefined number, for instance at least 5, 10, 15, 20, 25, 30, or 50 mutually adjacent second nozzles 18b. The position within the second nozzle array 14 of the second nozzles 18b to be set in the compensation mode may correspond to the position within the first nozzle array 16 of the malfunctioning first nozzles 18a with which they are paired.

The method represented in FIG. 3 may further comprise monitoring (at 408) the operation of the number of second nozzles 22 that are set in the compensation mode to determine whether a printing parameter of the number of second nozzles 22 differs from a reference printing parameter (condition 410). This may be implemented by the recalibration unit 250. The printing parameter of the number of second nozzles 22 may be detected by means of hardware components, software components or a combination thereof. In some examples, the printing parameter of the number of second nozzles 22 may be detected based on predetermined value tables or calibration tables that may be stored in the recalibration unit 250 or in a storage device connectable to the recalibration unit 250. Such value tables or calibration tables may comprise values defined by an analytical function.

In some examples, detecting the printing parameter of the number of second nozzles 22 may comprise comparing values of different calibration tables stored in the recalibration unit 250 or in a storage device connectable to the recalibration unit 250. Additionally or alternatively, detecting the printing parameter of the number of second nozzles 22 may comprise comparing measurements of an operation condition corresponding to malfunctioning and non-malfunctioning nozzles.

In some examples, the printing parameter that is monitored and compared to the predetermined printing parameter may be one of a color value, a drop weight, and a number of drops. “Drop weight” may refer herein to an absolute quantity of printing fluid that may be discretely ejected by a nozzle. “Number of drops” may refer herein to a number of drops of the printing fluid used for printing, for example a number of drops of ink ejected by a nozzle and having a given drop weight. A color value may be a value that is indicative of a color to be achieved on the printing medium 300 after printing and that is related to a corresponding number of drops. A color value may correspond or be related to a color saturation value, a color hue value or a chroma value. In some examples the reference printing parameter may be one of a color value, a drop weight, and a number of drops. The reference printing parameter may however also be a printing parameter related to a color value or a number of drops, such as a drop volume or a drop weight.

The reference printing parameter may be a printing parameter of nozzles other than the number of first nozzles 20 and the number of second nozzles 22, for example of first nozzles 18a other than the number of first nozzles 20, second nozzles 18b other than the number of second nozzles 22, or of first and second nozzles 18a and 18b other than the number of first nozzles 20 and the number of second nozzles 22. The printing parameter and the reference printing parameter need not correspond to the same kind of quantity, inasmuch as they can also be indirectly compared, by means of associated quantities or parameters or by means of an associated relationship. For example, the printing parameter may be a color value whereas the reference printing parameter may be a number of drops.

When a first nozzle 18a is not malfunctioning, a second nozzle 18b paired with the first nozzle may be operating in a non-compensated operation mode. In that situation, both the first nozzle 18a and the corresponding second nozzle 18b may be in a non-compensated operation mode and may eject printing fluid, for example ink of the same color, at the standard firing frequency FF1.

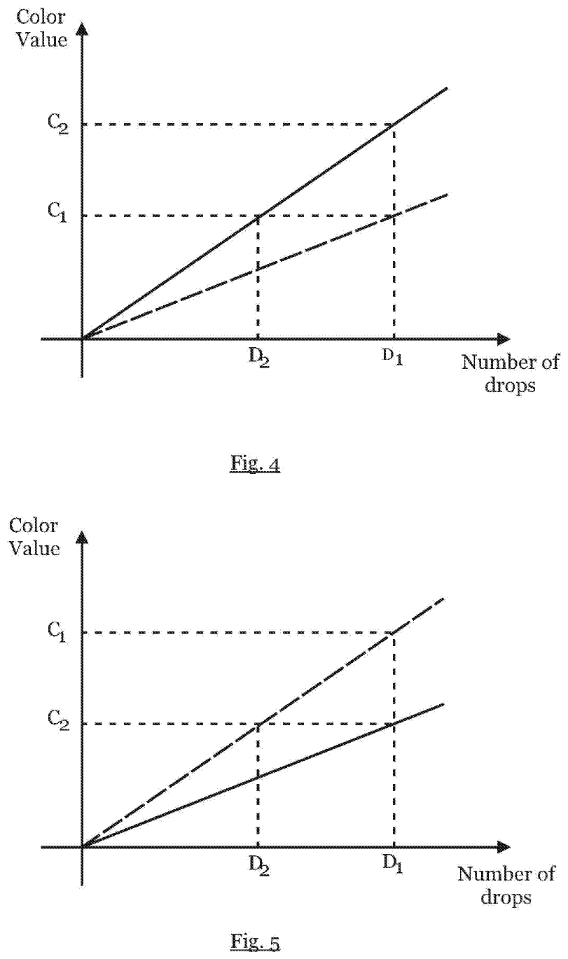

In order to achieve a given color when printing a first color value C1 on the printing medium 300, the first nozzle 18a and the paired second nozzle 18b may eject a first number D1 of drops that corresponds to the color value C1 according to a first color-drop ratio comprised in a first calibration table, that is plotted as a graph in FIG. 4 with a dashed line, which represents a first relation between color values and number of drops. For example, the first nozzle 18a and the second nozzle 18b may each eject D1/2 drops to achieve, in combination, the color value C1.

The control unit 200 monitors the operation of the first nozzles 18a and, if a malfunction of a number of the first nozzles 18a is detected, respective second nozzles 18b that are paired with the malfunctioning first nozzles 18a are set to operate in the compensation mode to eject printing fluid at the compensation firing frequency FF2. Due to the dependence of the drop weight upon the firing frequency, the drops of printing fluid ejected by the second nozzles 18b at the compensation firing frequency FF2 may have a different drop weight than the drops of printing fluid ejected by the second nozzle 18b and by the paired first nozzle 18a when operating in the non-compensated operation mode.

As a consequence, if the second nozzle 18b prints according to the first color-drop ratio (cf. dashed line in FIG. 4) when operating in the compensation mode, for achieving the color value C1, the second nozzle 18b will eject D1 drops of printing fluid at the compensation firing frequency FF2. However, due to the aforesaid difference in drop weight caused by the difference in the firing frequencies, when ejecting D1 drops of printing fluid at the compensation firing frequency FF2, the second nozzle 18b will not achieve the color value C1 but a different color value C2, as shown in FIG. 4.

If this happens for a significant number of nozzles, as it may be the case when there is a number of mutually adjacent first nozzles 20 malfunctioning, the number being greater than a predefined threshold, the difference between the color value C2 generated by the number of second nozzles 22 when trying to obtain the color value C1 and the color value C1 that is actually obtained by other nozzles 18a, 18b of the printhead device 10 may extend to a non-negligible part of the printing medium 300 after printing and be perceivable.

Therefore, the recalibration unit 250, the control unit 200, or a separate monitoring unit, may monitor the operation of the number of second nozzles 22 to detect whether a color value C2 generated by the number of second nozzles 22 in the compensation mode differs from the color value C1 generated in the non-compensated operation mode, i.e. by the non-malfunctioning first nozzles 18a and the second nozzles 18b that are paired with such first nozzles 18a, i.e. by first nozzles 18a not included in the number of first nozzles 20 and by paired second nozzles 18b not included in the number of second nozzles 22.

In some examples, monitoring the operation of the number of second nozzles 22 may comprise comparing the printing parameter and the reference printing parameter based on the predefined calibration tables, which may be stored in the printing device 100, for example in the recalibration unit 250, in the control unit 200 or in a separate monitoring unit, or in a storage device connected or connectable thereto.

The predefined calibration tables may comprise predetermined relations between one of the printing parameter or the reference printing parameter and a control printing parameter for different firing frequencies or drop weights. The control printing parameter may correspond to a number of drops. The predefined calibration tables may comprise predetermined color-drop ratios for different firing frequencies or drop weights. A color-drop ratio represents a predefined relation between values of the parameter color value and corresponding values of the parameter number of drops for a corresponding drop weight. Such a ratio may be determined during a development or manufacturing phase of a printing device and may be preloaded in the printing device. Additionally or alternatively, such a ratio may be incorporated into the printing device at a later time. Additionally or alternatively, a printing device may comprise a processing unit to determine such a ratio based on empirically detected color measurements from printed images on the printing medium 300.

For example, a first calibration table may comprise a first color-drop ratio for the standard firing frequency. A second calibration table may comprise a second color-drop ratio for the compensation firing frequency. FIG. 4 illustrates a first color-drop ratio corresponding to the standard frequency FF1 as a dashed line and a second color drop ratio corresponding to the compensation frequency FF2 as a continuous line.

For given printing settings of the printing device 100, a particular color to be printed on the printing medium 300 can be obtained by controlling the number of drops of printing fluid ejected from the nozzles 18a, 18b. Therefore, when a given color associated to a corresponding color value is to be printed on the printing medium 300, the nozzles 18a, 18b may be instructed to eject a corresponding number of drops according to a color-drop ratio corresponding to the non-compensated operation mode. If no nozzle is set to the compensation mode, the first color-drop ratio equally applies to all nozzles and the same control instructions to eject a given number of drops produces, when carried out by all nozzles, the same color on the printing medium 300.

If the number of second nozzles 22 is set to operate in the compensation mode, the first color-drop ratio may still apply to the non-malfunctioning first nozzles 18a and to the second nozzles 18b that are paired with them, which fire at the standard firing frequency FF1. However, the second color-drop ratio may apply to the number of second nozzles 22, which fire at the compensation firing frequency FF2.

Therefore, the same control instructions to eject a given number of drops may produce a first color corresponding to a first color value C1 for the non-malfunctioning first nozzles 18a and the second nozzles 18b that are paired with them and may produce a second color corresponding to a second color value C2 different from the first color for the number of second nozzles 22, due to the difference between the standard firing frequency and the compensation firing frequency, which results in a difference in drop weight, as illustrated in FIG. 4.

, The recalibration unit 250 may adjust an operation mode parameter of a subset of the nozzles of the printhead device 10 in order to compensate the difference between the first color value C1 and the second color value C2 (step 412 in FIG. 3), if it is detected that the second color value C2 obtainable by the number of second nozzles 22 when firing at the compensation firing frequency FF2 differs from the color value C1 obtainable by nozzles other than the number of second nozzles 22. For example, it may be detected example based on the first calibration table and the second calibration table that the second color value C2 differs from the color value C1 obtainable by non-malfunctioning first nozzles 18a and by the second nozzles 18b paired with them

In some examples, the operation mode parameter may be at least one of a color-drop ratio, a firing frequency and a drop weight. In the example shown in FIG. 4, the printing parameter of the number of second nozzles 22, i.e. the second color value C2, is greater than the reference printing parameter, i.e. the first color value C1 in this case.

As shown in FIG. 3, if this is the case, the recalibration unit 250 may adjust (at 412) the color-drop ratio of the number of second nozzles 22. The recalibration unit 250 may adjust that color-drop ratio such as to associate a second number D2 of drops with the first color value C1, wherein the second number D2 of drops corresponds to the number of drops necessary for achieving the first color value C1 when firing at the compensation firing frequency FF2 taking into account the drop weight corresponding to the compensation firing frequency FF2.

Further, the recalibration unit 250 may also adjust the firing frequency of the number of second nozzles 22, i.e. the compensation firing frequency FF2, such that the second number D2 of drops be ejected in the same time period in which the nozzles firing at the standard firing frequency FF1 eject D1 drops. This may comprise increasing or reducing the compensation firing frequency FF2. Notably, a drop weight variation due to this adjustment of the compensation firing frequency is negligible.

Thus, the color-drop ratio and the firing frequency of the number of second nozzles 22 may be recalibrated such that the second color value C2 be equal to the first color value C1. As a result of the adjustment by the recalibration unit 250, both the number of second nozzles 22 that are operating in the compensation mode and the remaining nozzles of the printhead device 10 achieve the same color value, i.e. print the same color on the printing medium 300 in spite of printing with different firing frequencies and hence different drop weights. This allows improving the quality of interpen error hiding.

In the example illustrated in FIG. 4, the second color value C2 obtained with a higher number of drops is, before the adjustment, higher than the first color value C1 obtained with a lower number of drops. Therefore, adjusting the operation mode parameter of the subset of nozzles may comprise reducing operation mode parameter, in this case the color-drop ratio and the firing frequency of the number of second nozzles 22. However, according to further examples, adjusting the operation mode parameter of the subset of nozzles may comprise increasing operation mode parameter, for example increasing the color drop ratio and the firing frequency of the number of second nozzles 22, for instance in cases in which the second color value C2 is, before the adjustment, lower than the first color value C1, as illustrated in FIG. 5.

According to some examples an operation parameter of nozzles other than the number of first nozzles 20 and the number of second nozzles 22 may be adjusted, if increasing the compensation firing frequency FF2 would lead to a target firing frequency, i.e. to a firing frequency after the adjustment, greater than a threshold firing frequency of nozzles of the printing device 100, for instance of the number of second nozzles 22. In this case, the subset may correspond to first and second nozzles 18a, 18b other than the number of first nozzles 20 and the number of second nozzles 22. Thereby, reaching or exceeding the threshold firing frequency as a consequence of the adjustment can be avoided. “Threshold firing frequency” refers herein to a maximum firing frequency supported by a nozzle of a printing device.

For example, adjusting the operation mode parameter of the subset of nozzles may comprise decreasing the color-drop ratio of nozzles other than the number of first nozzles 20 and the number of second nozzles 22 and decreasing the standard firing frequency FF1.

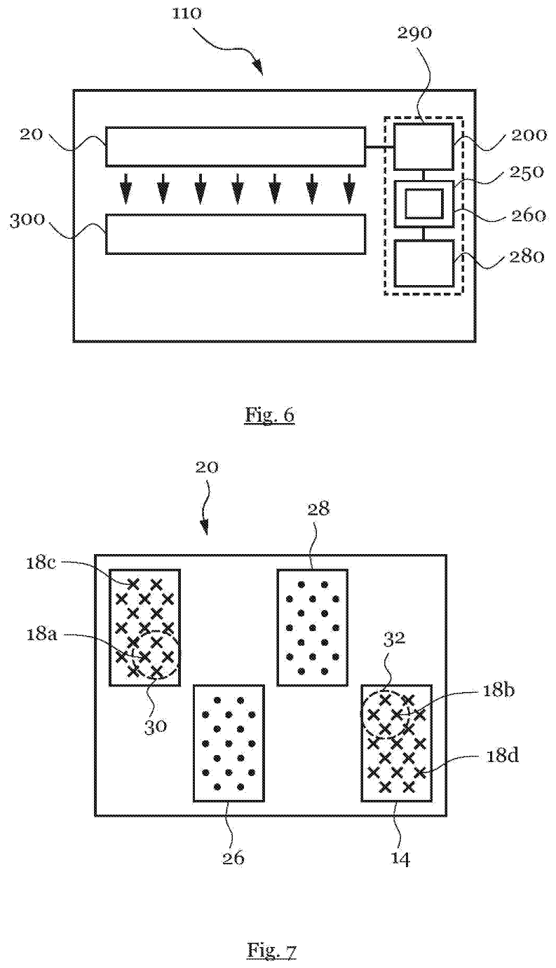

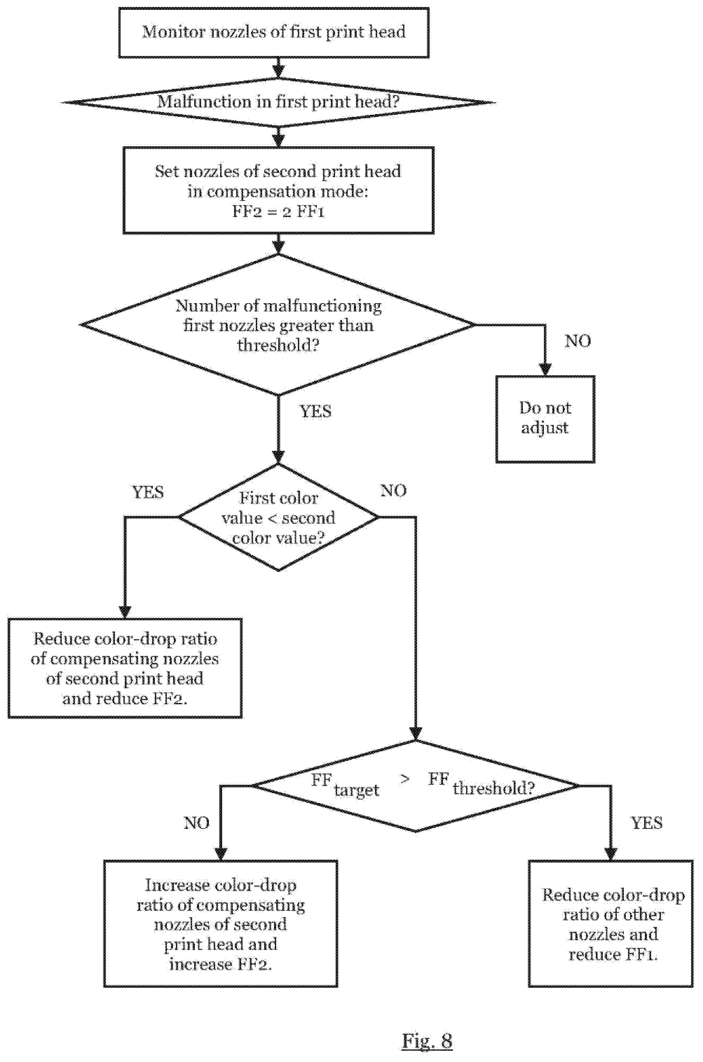

FIG. 6 shows a schematic illustration of a printing device 110 according to an example, which may correspond to a dye sublimation printer or an inkjet printer. The printing device 110 of FIG. 6 may comprise all components described for the printing device 100 of FIG. 1, which are indicated with the same reference signs. Further, the printing device 110 of FIG. 6 may comprise a recalibration module 260 to implement the method of printing according to an example that is illustrated in FIG. 8, and a storage device 280 comprising calibration tables like the calibration tables shown in FIGS. 4 and 5.

In the printing device 100 of FIG. 6, the control unit 200, the recalibration unit 250, the recalibration module 260 and the storage device 280 may be mutually interconnected and may be comprised in an combined control and recalibration unit 290. The control and recalibration unit 290 may be software-based, hardware-based, or a combination of both. In other examples, the storage device may be a remote device connectable to at least one of the control unit 200, the recalibration unit 250, and the recalibration module 260.

Further, as shown in FIG. 6, the printing device 110 may comprise a carriage 20 carrying a first printhead 16 and a second printhead 14, the wherein the first and second printheads 16, 14 may respectively include a first and a second nozzle array like those of the printing device 100 of FIG. 1 (cf. FIG. 2). An example of the carriage 20 is shown in FIG. 7.

The carriage 20 may further carry a third printhead 26 and a fourth printhead 28, which may be arranged with respect to each other in analogy to the arrangement of the first printhead 16 and the second printhead 14 in the carriage 20, such that the position of the nozzles of the third printhead 26 corresponds to the position of the nozzles of the fourth printhead 28, wherein the nozzles of the printhead 26 are paired with the nozzles of the fourth printhead 28. Although an example with four printheads 14, 16, 26, 28 is described, a carriage may carry any number of pairs of printheads. Further, any printhead may include one or a plurality of nozzle arrays like those of the printing device 100 of FIG. 1 (cf. FIG. 2).

Each nozzle 18a of the first printhead 16 may be paired with a corresponding nozzle 18b of the second printhead 14. The control unit 200 may monitor the first nozzles of the first printhead 16 and may control the first printhead 16 and a second printhead 14 such that, when a malfunction of a first group of nozzles or number of first nozzles 30 of the first printhead 16 is detected, the control unit 200 may set a corresponding second group of nozzles or number of second nozzles 32 of the second printhead 14 that is paired with the first group of nozzles 30 from the non-compensated operation mode to the compensation mode, which may comprise setting the second group of nozzles 32 to eject printing fluid at the compensation firing frequency FF2.

If the first group of nozzles 30 does not comprise more than a predefined number of mutually adjacent malfunctioning nozzles 18a, for example more than 30 nozzles, no further steps may be carried out. No adjustment may be deemed to be necessary in this situation, since the number of nozzles in the compensation mode would not cause a difference in the firing frequencies or the drop weights perceivably manifesting in the printing medium 300 after printing.

If the number of malfunctioning mutually adjacent first nozzles 18a in the first group of nozzles 30 is at least the predefined threshold, the recalibration unit 250 may adjust a color-drop ratio and a firing frequency of a subset of the nozzles of the first printhead 16 and the second printhead 14, such that a second color value C2 obtainable by the second group of nozzles 32 equals a first color value C1 obtainable by nozzles other than the second group of nozzles 32 and the first group of nozzles 30, for example by a first nozzle 18c and a second nozzle 18d.

For the purpose of monitoring the first and second color values, the recalibration module 250 of the recalibration unit 260 may use a first calibration table and a second calibration table like the first and second calibration tables described above with respect to FIGS. 4 and 5, which can be received or obtained from the storage device 280.

If it is detected that the second color value C2 exceeds the first color value C1 (cf. calibration table of FIG. 4), the subset may correspond to the second group of nozzles 32 and the recalibration module 260 may reduce the color-drop ratio and the firing frequency of the second group of nozzles 32.

If it is detected that the second color value C2 does not exceed the first color value (cf. calibration table of FIG. 5), the recalibration module may determine whether increasing the firing frequency of the second group of nozzles 32 would lead to a target firing frequency greater than a threshold firing frequency of the nozzles of the printing device 110.

If the target firing frequency does not exceed the threshold firing frequency, the subset may correspond to the second group of nozzles 32 and the recalibration module 260 may increase the color-drop ratio and the firing frequency of the second group of nozzles 32.

If the target firing frequency would exceed the threshold firing frequency, the subset may correspond to first and second nozzles 18c, 18d other than the first group of nozzles 30 and the second group of nozzles 32 and the recalibration module 260 may decrease the color-drop ratio and the firing frequency of such nozzles other than the first group of nozzles 30 and the second group of nozzles 32. This may allow achieving the same color value both with the second group of nozzles 32 and with the remaining nozzles of the first printhead 16 and the second printhead 14 without exceeding the threshold firing frequency.

Specific examples of a method of printing and a printing device according to the present disclosure have been described herein in greater detail with reference to FIGS. 1 to 8. However, the description of the examples in the figures merely serves to illustrate the disclosure and should not be construed to imply any limitation. The scope of this disclosure is to be determined based on the appended claims.

1. A method of printing, the method comprising:
monitoring operation of first nozzles of a first nozzle array; and if malfunction of a number of first nozzles of the first nozzle array is detected:
setting a number of second nozzles of a second nozzle array to a compensation mode;
monitoring operation of the number of second nozzles in the compensation mode; and
in response to detecting that a printing parameter of the number of second nozzles differs from a reference printing parameter:
adjusting an operation mode parameter of a subset of second nozzles.

2. The method of claim 1, wherein setting the number of second nozzles to the compensation mode includes controlling the number of second nozzles to operate at a compensation firing frequency higher than a standard firing frequency of a non-compensated operation mode.

3. The method of claim 2 wherein the compensation firing frequency is twice or about twice or at least twice the standard firing frequency of the non-compensated operation mode.

4. The method of claim 1 wherein the number of first nozzles comprises at least one first nozzle, or at least a predefined number of first nozzles, wherein the predefined number is 5, 10, 15, 20, 25, or 30, wherein the number of first nozzles are adjacent to each other.

5. The method of claim 4 wherein the number of second nozzles equals the number of first nozzles.

6. The method of claim 5, wherein the reference printing parameter is one of a color value, a drop weight and a number of drops, and wherein the reference printing parameter is a printing parameter of first nozzles, second nozzles, or first and second nozzles, other than the number of the first nozzles and the number of the second nozzles, and
wherein the printing parameter is one of a color value, a drop weight and a number of drops.

7. The method of claim 1, wherein the operation mode parameter is at least one of a color-drop ratio, a firing frequency, and a drop weight.

8. The method of claim 1, wherein the printing parameter is a color value of the number of second nozzles, the reference printing parameter is a reference color value of first nozzles, second nozzles, or first and second nozzles, other than the number of the first nozzles and the number of the second nozzles, and wherein the operation mode parameter corresponds to a color-drop ratio and a firing frequency.

9. The method of claim 8, wherein the subset corresponds to the number of second nozzles;
wherein the adjusting comprises reducing the color-drop ratio and the compensation firing frequency if the color value exceeds the reference color value, and
wherein the adjusting comprises increasing the color-drop ratio and the compensation firing frequency if the color value does not exceed the reference color value and if a target firing frequency of the number of second nozzles does not exceed a threshold firing frequency of the second nozzles.

10. The method of claim 8, wherein the subset corresponds to nozzles other than the number of second nozzles and the number of first nozzles, and
wherein the adjusting comprises decreasing the color-drop ratio and the standard firing frequency if the color value does not exceed the reference color value and if a target firing frequency of the number of second nozzles exceeds a threshold firing frequency of the second nozzles.

11. A printing device comprising:
a printhead device comprising a first nozzle array comprising first nozzles and a second nozzle array comprising second nozzles,
a control unit to control the first and second nozzle arrays to, if a malfunction of a number of the first nozzles is detected, set a number of the second nozzles in a compensation mode, and
a recalibration unit to adjust an operation mode of a subset of the second nozzles, when detecting that a printing parameter of the number of second nozzles differs from a reference printing parameter.

12. The printing device of claim 11, wherein the first and second nozzle arrays are part of first and second printheads that eject a same type of printing fluid.

13. The printing device of claim 12, wherein the number of second nozzles is located at a position within the second nozzle array corresponding to a position of the number of first nozzles in the first nozzle array.

14. A printing device comprising:
a carriage comprising a first printhead and a second printhead, wherein each nozzle of the first printhead is paired with a corresponding nozzle of the second printhead,
a control unit to control the first and second printheads to, when a malfunction of a first group of nozzles of the first printhead is detected, set a corresponding second group of nozzles of the second printhead paired with the first group of nozzles from a non-compensated operation mode to a compensation mode,
a recalibration unit to adjust a color-drop ratio and a firing frequency of a subset of nozzles of d, such that a second color value obtainable by the second group of nozzles equals a first color value obtainable by the nozzles other than the second group of nozzles, if the number of nozzles of the first group of nozzles is greater than a predefined threshold, wherein the recalibration unit comprises:
a recalibration module to:
reduce the color-drop ratio and the firing frequency of the second group of nozzles if the second color value exceeds the first color value, the second group of nozzles corresponding to the subset,
increase the color-drop ratio and the firing frequency of the second group of nozzles if the second color value does not exceed the first color value and if, before the adjustment, a target firing frequency of the second group of nozzles does not exceed a threshold firing frequency of the second group of nozzles, the second group of nozzles corresponding to the subset, and
reduce the color-drop ratio and the firing frequency of nozzles other than the second group of nozzles if the second color value does not exceed the first color value, and if, before the adjustment, the target firing frequency of the second group of nozzles exceeds the predefined threshold firing frequency of the second group of nozzles, the nozzles of the second printhead other than the second group of nozzles corresponding to the subset.

15. The printing device of claim 14, wherein the printing device is a dye sublimation printer or an inkjet printer, and wherein the predefined threshold is 5, 10, 25, 30, 25, or 30, wherein the number of first nozzles are adjacent to each other.
